(19) United States
(12) Patent Application Publication
(10) Pub. No.: US 2009/0286055 A1
(43) Pub. Date: Nov. 19, 2009

(54) Methods and Devices for Providing Flexible Electronics

(76) Inventors: Behnam Pourdeyhimi, Cary, NC (US); Edward Grant, Raleigh, NC (US); H. Troy Nagle, Durham, NC (US); Carey Reid Merritt, Oak Ridge, NC (US); Burcak Karaguzel, Raleigh, NC (US); Tae-Ho Kang, Raleigh, NC (US); John Michael Wilson, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/092,738

(22) PCT Filed: Nov. 8, 2006
(86) PCT No.: PCT/US06/43749

§ 371 Date: Mar. 11, 2009

Related U.S. Application Data
(60) Provisional application No. 60/734,548, filed on Nov. 8, 2005.

(51) Int. Cl. B32B 3/00; B32B 38/14

(52) U.S. Cl. 428/201; 156/277

(57) ABSTRACT

Methods and devices for providing flexible electronics are described. In an exemplary embodiment of the present invention, a conductive ink is applied to a nonwoven substrate. More particularly, the exemplary embodiment provides a nonwoven substrate with a general depth in the z-direction and a conductive ink carried by the nonwoven substrate on the surface of the substrate and at least partially but no more than 50% within the nonwoven substrate in the z-direction.

### BENEFIT CLAIMS TO PRIOR APPLICATIONS

This application claims the benefit of U.S. Provisional Application No. 60/734,548, filed 8 Nov. 2005.

### FIELD OF INVENTION

The invention relates in general to a flexible electronic device and more particularly to methods and devices for providing flexible electronic devices that are resilient and capable of withstanding washings and multiple wearings.

### BACKGROUND OF INVENTION

The overwhelming majority of electronic circuitry for commercial embodiments is constructed on traditional metallic or alloy substrates, such as the copper of Printed Circuit Boards (PCBs). While PCBs and other similar substrates are not ideal for a wide variety of electronic applications and implementations, the application of conductive circuitry to other substrates has been limited. The incorporation of circuitry into fabrics, for example, has been done in very limited capacities. For example, some basic and low level circuitry has been incorporated into t-shirts and children's toys, such as stuffed animals. The prior art contains limited examples of attempts to incorporate electronic circuitry onto flexible substrates.

U.S. Pat. No. 4,790,968 to Ohkawa et al. (“'968 Patent”) disclosed a concept of producing a pressure-sensitive electroconductive sheet on a flexible porous substrate. In the method described, an ink is applied to a flexible porus substrate, such as a resin film or woven fabric, in a manner that allows the ink to permeate to the opposite side of the substrate. After application of the ink, the '968 Patent requires that the flexible porous substrate be reinforced with a pressure-sensitive conductive paste or insulating silicone rubber which permeate the substrate and cure in the substrate.

U.S. Pat. No. 5,371,657 to Wiscombe (“'657 Patent”) discloses an illuminated fabric article which includes a flexible substrate sheet to which conductive ink traces and lights attach. The substrate sheet includes a film layer overlaid upon a woven cloth backing. The film layer provides a base upon which the conductive traces are applied. The patent discloses that the gaps between the fibers of the film layer as so small that they are insignificant for supporting continuous runs of conductive traces. The patent further discourages the use of the woven cloth backing for conductive ink traces because of wicking and the likelihood of circuit openings after curing. Therefore, the conductive circuitry of the '657 Patent is applied to the film layer, and the film layer is then attached to the woven backing, such as a T-shirt.

U.S. Pat. No. 5,371,326 to Clearwaters-Dreager et al. (“'326 Patent”) teaches an electrical conductor incorporated into the material of a soft children's toy. The '326 Patent describes the application of a conductive paint to a nonwoven fabric with a quantity sufficient to soak into the fibers of the fabric. The fabric is then cured at a predetermined temperature. The '326 Patent describes that the resulting electronic circuitry in the fabric is used in the manufacture of a children's battery powered toy to provide pressure sensitive switches in the toy.

However, while suitable for there intended purpose, there has been a need for incorporation of circuitry into wearable fabrics which can withstand the day to day forces typical to clothing, such as washings and other deforming stresses.

Textiles provide an excellent substrate for circuitry. Textile structures are characterized by their ability to withstand high levels of stress and strain. Textiles may inflate, flex and conform to almost any desired shape. Apart from clothing and upholstery, textile structures are used in engineering applications as ropes, cables, filter media and reinforcement for composites.

Fabrics from textiles may be classified as woven or nonwoven. Woven fabrics typically exist of natural or extruded fibers which are spun or twisted in yarns. The yarns are subsequently woven into a fabric or knitted.

While it has been know to place circuitry onto woven fabrics via heat transfer, woven fabrics have deficiencies in forming suitable substrates for screen printed conductive inks. Typically in woven structures there are two pore sizes; one corresponds to the spaces between the yarns and the other corresponds to the pores among fibers in the yarns. Accordingly circuits applied to woven fabrics have typically been pre-designed and transferred onto the fabric. When circuits have been printed onto the woven structures with ink, the ink tends to go through the interstices between the yarns and the pores in the yarns. The resolution of the printing is limited to the yarn diameter and yarn spacing. Fine resolution can only be obtained by highly dense and lightweight woven structures.

Consequently, while suitable for their intended purposes, woven fabrics are not the best suited for electrical substrates. A better alternative includes the utilization of nonwoven textiles as the base substrate. Nonwoven structures have many configurations and include such well known fabrics as Evolon® and TYVEK®. Nonwovens are comprised of fibers which are flexible, lightweight, and inexpensive to manufacture.

Therefore, a need exists for a flexible electronic device comprised of a nonwoven fabric.

Additionally, a need exists for a flexible electronic device capable of withstanding exposure to significant deforming stresses.

### BRIEF SUMMARY OF THE INVENTION

Briefly described, in a preferred form, the present invention is a system and method for providing flexible electronics. In an exemplary embodiment of the present invention, a conductive ink is applied to a nonwoven substrate. More particularly, the exemplary embodiment provides a nonwoven substrate with a general depth in the z-direction and a conductive ink carried by the nonwoven substrate on the surface of the substrate and at least partially but no more than 50% within the nonwoven substrate in the z-direction.

These and other objects, features and advantages of the present invention will become more apparent upon reading the following specification in conjunction with the accompanying drawings.

### BRIEF DESCRIPTION OF THE FIGURES

FIG. 1A displays a method of providing a flexible electronic component 100A in accordance with an exemplary embodiment of the present invention.

FIG. 1B displays a flexible electronic component 100B in accordance with an exemplary embodiment of the present invention.

FIG. 2A displays an electrical component 200A in accordance with an exemplary embodiment of the present invention after the application of the conductive ink.

FIG. 2B displays an electrical component 200B in accordance with an exemplary embodiment of the present invention after the application of the conductive ink.

FIG. 3 displays the results of the printing of three types of conductive ink on two types of nonwoven substrates in accordance with an exemplary embodiment of the present invention.

FIG. 4 illustrates the coplanar waveguide lines for an electrical component in accordance with an exemplary embodiment of the present invention.

FIG. 5 illustrates the circuit patterns created within an electrical component in accordance with an exemplary embodiment of the present invention.

FIG. 6 illustrates various contact angles at particular instances of time for different conductive inks applied to different nonwoven substrates in accordance with an exemplary embodiment of the present invention.

FIG. 7 displays the results of washing electrical components created on various nonwoven substrates after the application of the conductive ink.

FIG. 8 displays the results of the exposure of an electrical component 800 created in accordance with an exemplary embodiment of the present invention to deforming stress.

FIG. 9 provides a series of time-domain reflectometry graphs of three electrical components created in accordance with an exemplary embodiment of the present invention.

FIG. 10 provides a time-domain reflectometry graph for an electrical component in accordance with an exemplary embodiment of the present invention.

### DETAILED DESCRIPTION OF THE PREFERRED EMBODIMENTS

The present invention addresses the deficiencies in the prior art by providing an electrical component that is flexible, stable, reliable, robust and durable. Various embodiments of the present invention enable an electrical garment that exhibits the integrity, look, feel, wash, and wear or ordinary clothing. Furthermore, exemplary embodiments of the present invention utilize a durable lamination method with protects the integrity of the electrical component while at the same time not impeding flexibility of the overall device.

In an exemplary embodiment of the present invention, a conductive ink is applied to a nonwoven substrate. More particularly, the exemplary embodiment provides a nonwoven substrate with a general depth in the z-direction and a conductive ink carried by the nonwoven substrate on the surface of the substrate and at least partially but no more than 50% within the nonwoven substrate in the z-direction.

The invention focuses on interconnecting fiber-based components with conventional silicon-based technologies in a manner which provides for reliable interconnections. This can enable the development of electronic textile devices that sense, actuate, display and process data. To date most work involving interfacing electrical components with fabrics has been concentrated on adapting woven and knitted structures and using wires and conductive fibers to create pathways for power and data transmission. Not only are these techniques and methods costly and time intensive, the resulting interconnects are not durable and they cannot be bent or washed.

Applicants have created a method of applying conductive ink to nonwoven fabrics in a manner which produces circuits that maintain their conductivity subsequent to washings and other common wear and tear. The application of the conductive ink to the nonwoven fabric takes into consideration the interaction between the conductive ink and fabric for providing a printed circuit which satisfies the needs of the invention. Such considerations can include the fabric's surface energy or wettability, the fiber orientation distribution and structure, the fiber size, the smoothness of the fabric softness, the ink's viscosity and other processing conditions such as the velocity of the applied ink, the contact angle of the ink and how far the ink is positioned into the fabric. The control and manipulation of these factors can lead to certain desired characteristics in the resulting flexible electronic component.

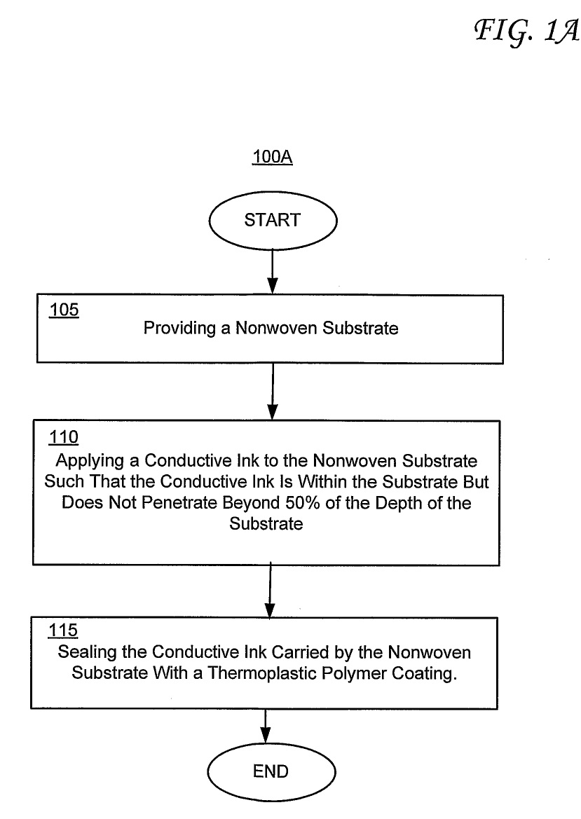

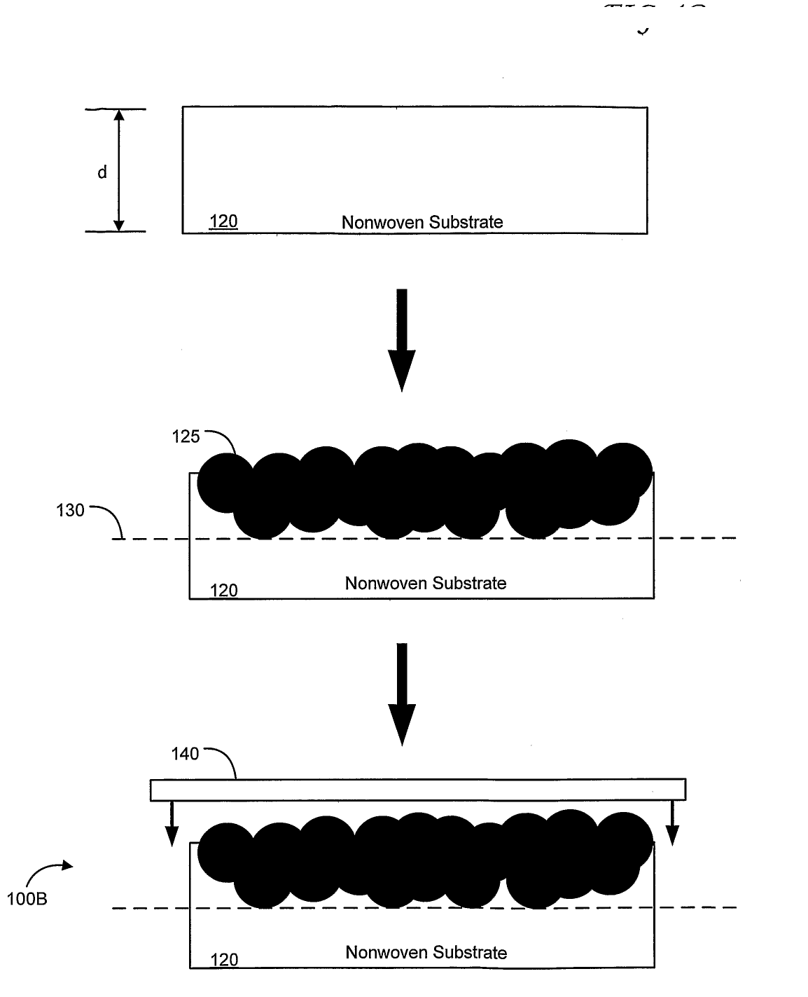

FIG. 1A displays a method of providing a flexible electronic component 100A in accordance with an exemplary embodiment of the present invention. As shown in FIG. 1A, the first step 105 of the method involves providing a nonwoven substrate having a general depth in the z-direction. In the second step 115, a conductive ink is applied to the nonwoven substrate. The conductive ink is applied in the second step 115 such that it is carried by the nonwoven substrate on the surface of the substrate and at least partially but no more than 50% within the substrate in the z-direction. Furthermore, step three 120 requires that the conductive ink carried by said nonwoven substrate be sealed with a laminate coating. Thereby, a durable and flexible electronic component is provided.

FIG. 1B displays a flexible electronic component 100B in accordance with an exemplary embodiment of the present invention. As shown in FIG. 1B, a nonwoven substrate 120 is provided having a general depth “d” in the z-direction. In an exemplary embodiment, a conductive ink 125 is applied to the nonwoven substrate 120. The conductive ink 125 can be applied in an exemplary embodiment such that it is carried by the nonwoven substrate 120 on the surface of the substrate and at least partially but no more than 50% within the substrate in the z-direction. Thereby, the conductive ink 125 penetrates the surface of the nonwoven substrate 120, but not by more than half the distance of “d,” shown in FIG. 1B by dashed line 130. In an exemplary embodiment, the conductive ink 125 carried by said nonwoven substrate can be sealed with a laminate coating 140. Thereby, a durable and flexible electronic component 100B is provided.

The utilization of nonwoven materials as the substrates for the various embodiments of the present invention is advantageous, as the structure of the nonwoven fabric can be selected according to the demands of the implementation. Preferably, the orientation of the fibers are such that the ink enters into the fabric structure only to an extent less than or equal to 50% of the depth of the fabric in the z-direction, the z-direction being the depth of the fabric as opposed to its length which is the x-direction and width which is the y-direction. The fiber size is preferably less than 10 microns in diameter. Some fabric has been utilized wherein the fibers are only 0.5 microns. Many different types of nonwoven materials are commercially available and present viable materials for implementation in the exemplary embodiments of the present invention. Three exemplary nonwoven materials are Freudenberg's Evolon®, BBA FiberWeb's Resolution Print Media (“RPM”), and DuPont's Tyvek®. Tyvek® is a flash spun, highly calendared structure, which is made from polyethylene fibers. Evolon has a plasma treated surface, which helps the bonding of the conductive ink to the substrate. Tyvek® has very few and small capillaries on the surface. Evolon® is a spunbonded hydroentangled structure with splittable fibers of polyester and nylon. It has a three dimensional structure with very fine fibers of 1.5 microns in diameter. BBA Fiberweb's RPM is a spunbonded substrate made of unique trilobal-shaped polyester fibers which provides increased surface area for better print definition. The fiber size of Resolution Print Media is around 25 to 30 microns. Table 1 below provides a summary of the characteristics of particular Evolon® and Tyvek® materials used as the nonwoven substrate in the exemplary embodiments of the present invention.

TABLE 1

Fabric type

| | Evolon ® | Tyvek ® |
|---|---|---|
| Process | Spunbonded/ | Flashspun/ |
| | Hydroentangled | Calendered |
| Fiber type | PET/Nylon | PE |
| Fiber size (μm) | 1.5 | 4 |
| Thickness (μm) | 400 | 300 |
| Basis Weight | 100 | 150 |
| (g/m²) | | |

| | Mean | | | |
|---|---|---|---|---|
| | (Std) | Min. | Max. | |
| Pore Size (μm) | 9 | 18 | 91 | No pores |
| | (16) | | | detected |

| | | |
|---|---|---|
| Bending Stiffness | 1300 | 4764 |
| (μN · m) | | |
| Air Permeability | 3000-4000 | 500 |
| (grams/m²/day) | | |

Those of skill in the art will appreciate that the data provided in Table 1 is merely representative of an exemplary embodiment of each nonwoven material and the specifications for the nonwoven materials could change without departing from the scope of the invention. For example, and not limitation, the fabric Evolon® manufactured by Freudenberg can be utilized with the Evolon®fabric having fibers of 2 microns in diameter. In an exemplary embodiment, an Evolon® fabric sample can have a thickness of 0.467 millimeters and a weight of 100 g/m². The Evolon® sample can have pores, openings in the surface leading into the fabric, from the range of 9.0327 μm to 91.941 μm with a mean pore diameter of 18.6041 μm. An alternate embodiment of the a TYVEK® nonwoven substrate had a thickness of 0.315 millimeters and a weight of 149 g/m². Regarding the permeability of Tyvek and Evolon, below are the moisture vapor permeation results:

For Evolon®=44355.38 (grams/m² day)
For TYVEK®=478.475 (grams/m²day)

A significant aspect of the exemplary embodiments of electric components of the present invention is the ability of the fabric to receive the conductive ink. Consequently, in understanding that an important component of the invention involves the positioning of the ink within the fabric in the z-direction; thus it is important to understand the control of movement of the conductive ink in the through-plane (z axis) and in-plane (along the x and y axis). The control of the movement of the conductive ink involves the interrelationship of the conductive ink with the fabric itself.

Nonwoven fabrics are advantageous for exemplary embodiments of the present invention because of their relatively cheap manufacturing costs and the ability to control the orientation of the fibers to permit multiple pores to exist within the fabric surface. These pores and their frequency can permit multiple areas for the conductive ink to permeate into the fabric in the z-direction. This can enable a strong circuit by having the ink withheld within the fabric structure due to the multiple surface interfaces between the conductive ink and nonwoven fabric. Also, by providing for a high plurality of pores, a high resolution image can be created as multiple pore receptacles are available.

In nonwoven fabrics, the fibers can typically be planer and can be interlaid upon each other layer upon layer creating channels in the x and y direction and pores in the z-direction. These channels and pores can be linear. Accordingly one way to integrate the conductive ink into the fabric is to utilize a fabric which has a lot of pores. Such pores exist within nonwoven fabrics which have been hydroentangled. Evolon® is an example of a nonwoven fabric which has been hydrotangled. An alternative method of achieving sufficient incorporation into a nonwoven fabric is to drop the conductive ink into the fabric at high velocities from ink jets and the like.

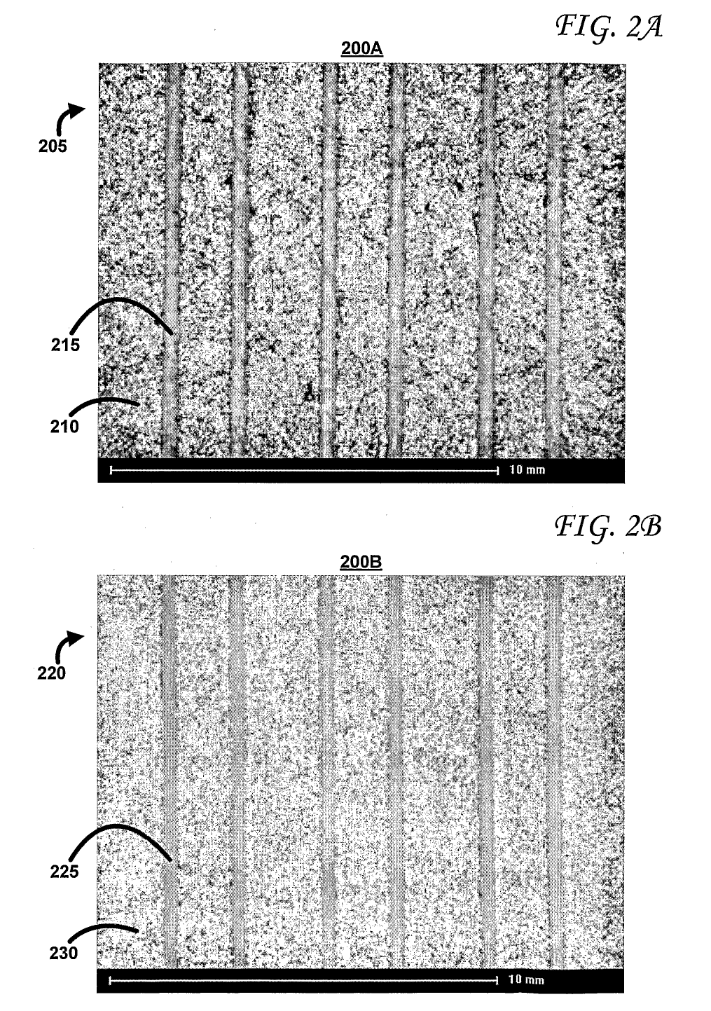

FIG. 2A displays an electrical component 200A in accordance with an exemplary embodiment of the present invention after the application of the conductive ink. The nonwoven substrate 205 shown in FIG. 2A is composed of a Evolon® material of 100 gsm. In the exemplary embodiment depicted in FIG. 2A, a conductive ink has been screen printed to the nonwoven substrate 205 in accordance with the methods of the present invention. The lines between the areas of conductive ink illustrate the gaps, such as gap 215, between the conductive ink traces, such as conductive ink trace 210. In an exemplary embodiment, the conductive ink traces, such as conductive ink trace 210, can be configured to create an electronic circuit.

The printing of the conductive ink to the nonwoven substrate in accordance with embodiments of the present invention can be accomplished in a number of different manners. In an exemplary embodiment, the printing is executed by a screen printer. In a non-limiting example, the screen printer can be a printer such as the DeHaart EL-20 flatbed semi-automatic screen printer with a dual squeegee print head. Numerous variables can be modified in the screen printing process, including the mesh count of the screen squeegee durometer, snap-off distance, and print speed, to achieve the desired results for a particular implementation. Once printing has been completed, in an exemplary embodiment, the printed samples can be cured in order to bond and fix the conductive ink at temperatures appropriate for the type of conductive ink employed and within safe temperatures for the nonwoven substrate.

FIG. 2B displays an electrical component 200B in accordance with an exemplary embodiment of the present invention after the application of the conductive ink. The nonwoven substrate 220 shown in FIG. 2B is composed of a Tyvek® material. In the exemplary embodiment depicted in FIG. 2B, a conductive ink has been screen printed to the nonwoven substrate 220 in accordance with the methods of the present invention. The lines between the areas of conductive ink illustrate the gaps, such as gap 225, between the conductive ink traces, such as conductive ink trace 230. In an exemplary embodiment, the conductive ink traces, such as conductive ink trace 230, can be configured to create an electronic circuit.

As can be surmised from a comparison of FIGS. 2A and 2B, the different nonwoven substrate materials result in different characteristics for the electrical components 200A and 200B. Due to the fact that the surface of the TYVEK® nonwoven substrate 220 of electrical component 200B is smoother and more calendared than that of the Evolon® nonwoven substrate 205 of electrical component 200A, the conductive ink traces on the surface of TYVEK® nonwoven substrate 220 appears smoother than that of the Evolon® nonwoven substrate 205 of electrical component 200A. This was due to the fact that TYVEK® nonwoven substrate materials lack sufficient pores to enable the conductive ink to substantially penetrate into the z-direction. Evolon® nonwoven substrate material, on the other hand, is sufficiently porous to allow substantial penetration into the z-direction by the conductive ink. Thereby, the resulting conductive ink traces, such as conductive ink trace 215 shown in FIG. 2A, appear less uniform due to the greater surface roughness.

Various conductive inks or differing viscosities and percentages of conductive particles can be used in accordance with the embodiments of the present invention. In an exemplary embodiment, the conductive ink is a silver ink with a relatively high silver particle percentage in its ink formulation. As non-limiting examples, three different types of conductive inks are described herein for use in the embodiments of the present invention. Those of skill in the art will appreciate that alternative conductive inks could be used without departing from the scope of the invention. Non-limiting examples of conductive inks include Creative Materials CMI 112-14, DuPont 5025, Precisia, and DuPont 5096. Table 2 below illustrates the relevant characteristics of these three types of conductive ink.

TABLE 2

| | Creative Materials | DuPont 5025 | DuPont 5096 |
|---|---|---|---|
| Viscosity | 490 p | 120 p | 340 p |
| at 50 rpm | | | |
| Surface Tension | 39 (dynes/cm) | 31 (dynes/cm) | 36 (dynes/cm) |

As shown in Table 2, the Creative Materials conductive ink has the highest viscosity (490 poise) and surface tension among the listed conductive inks. The higher viscosity of the Creative Materials conductive ink can be attributed to the higher silver particle percentage of its ink formulation. Viscosity and surface tension of the conductive inks have an impact on the performance of the printed media. The surface tension relative to the surface of the nonwoven affects the dispersion of the ink into the various substrates. Higher viscosity conductive ink may hinder the movement of the conductive ink in the z-direction in the substrate, resulting in less spread.

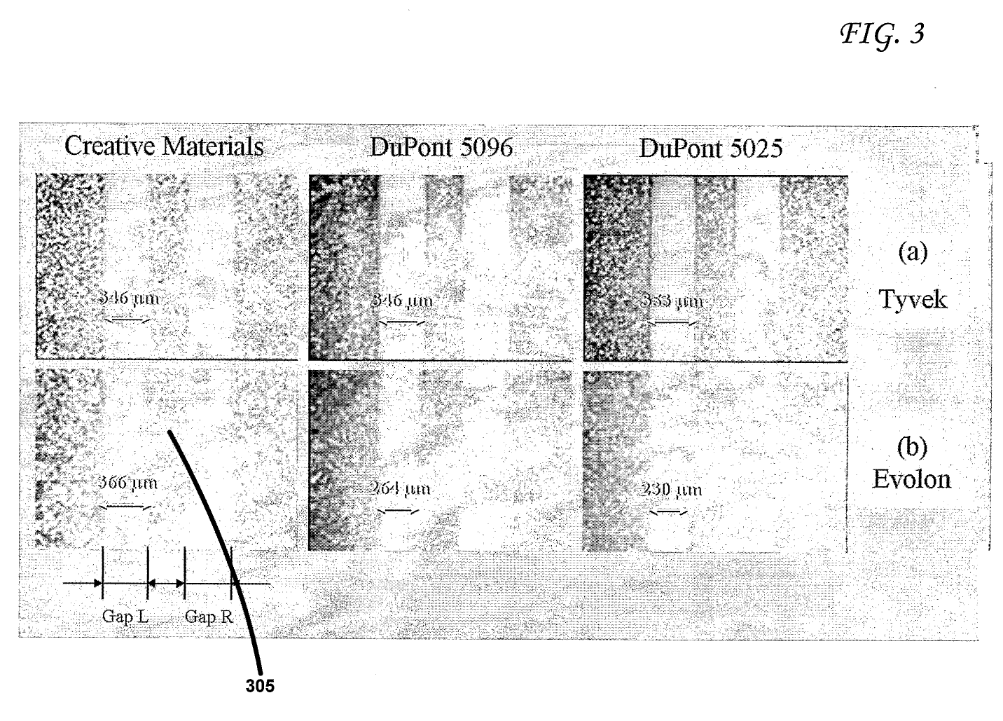

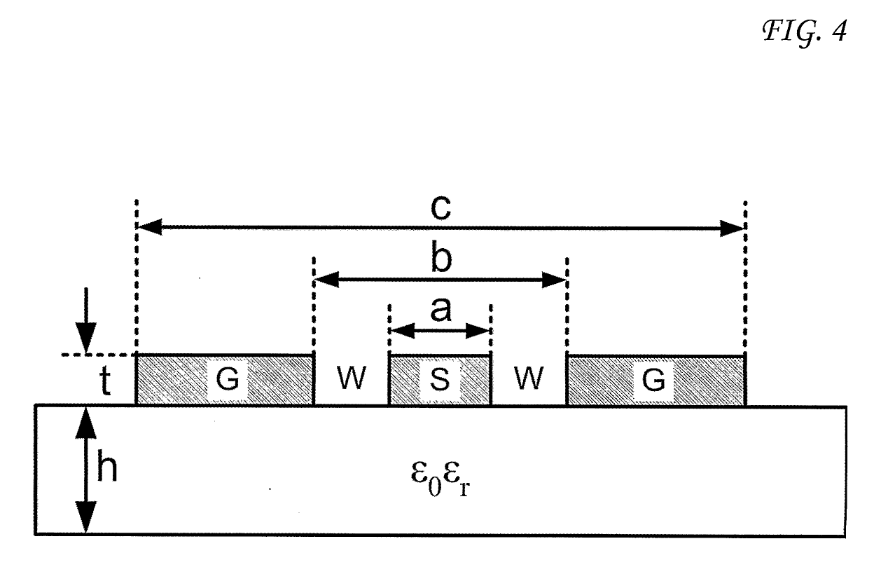

FIG. 3 displays the results of the printing of three types of conductive ink on two types of nonwoven substrates in accordance with an exemplary embodiment of the present invention. As shown in FIG. 3, the Creative Materials conductive ink has printed traces with wider signal lines and smaller gaps in comparison to the other embodiments. This is due to the higher ink deposition of the higher viscosity ink. However, with DuPont 5096 conductive ink and the Dupont 5025 conductive ink on Tyvek®, the gap between the lines are larger than that of Evolon®, as shown in FIG. 3. This can be attributed to the fact that lower viscosity ink yields less ink deposition over the substrate. On Evolon®, since DuPont inks have lower viscosity, they spread more, the gap between the lines gets smaller going from Creative Materials ink to DuPont inks, as shown in the lower row of FIG. 3.

As shown in the lower left corner of FIG. 3, the gap distance between traces in the various embodiments of the electrical components shown in FIG. 3, can be quantified as a Gap R on the right-hand side of the signal line 305 and Gap L on the left-hand side of the signal line 305. The gap distances of the exemplary embodiments of the electrical components shown after the printing of the conductive ink onto the nonwoven substrate were measured. Table 3 below provides the results of those measurements and a comparison of the data to a potentially ideal circuit pattern.

TABLE 3

| | Gap-L | Signal | Gap-R | | % E | % Error |
|---|---|---|---|---|---|---|
| Substrate | (μm) | (μm) | (μm) | % E Gap-L | Signal | Gap-R |
| Ideal G-S-G | 400 | 1400 | 400 | 0.00 | 0.00 | 0.00 |
| Creative Materials, Evolon | 366 | 1399 | 366 | −8.29 | −0.04 | −8.29 |
| Creative Materials, Tyvek | 346 | 1460 | 312 | −13.38 | 4.33 | −21.88 |
| DuPont 5025, Evolon | 230 | 1555 | 271 | −42.26 | 11.12 | −32.07 |
| DuPont 5025, Tyvek | 353 | 1426 | 312 | −11.69 | 1.88 | −21.88 |
| DuPont 5096, Evolon | 264 | 1535 | 264 | −33.76 | 9.67 | −33.76 |
| DuPont 5096, Tyvek | 346 | 1447 | 312 | −13.38 | 3.36 | −21.88 |

The first row of Table 3 is the ideal signal width of 1400 um. The percent error (% E) corresponds to how the printed lines compare to the ideal circuit pattern. As shown in Table 3, the Creative Materials conductive ink applied to the Evolon® nonwoven substrate yielded the lowest error percentage for the tested electronic components.

FIG. 4 illustrates the coplanar waveguide lines for an electrical component in accordance with an exemplary embodiment of the present invention. As shown in FIG. 4, a circuit can be enabled by the screen printing of conductive ink onto a nonwoven substrate. In an exemplary embodiment, the screen printed coplanar waveguide lines can include a center conductor that acts as the signal (S) while being surrounded by two ground planes (G). FIG. 4 shows the cross-section of a coplanar waveguide ground-signal-ground (GSG) structure indicating the dimensions that influence the characteristics of the line where “a” is the signal width, “W” is the signal-ground gap, “h” is the height of the substrate and “t” is the thickness of the conductive ink (ink height).

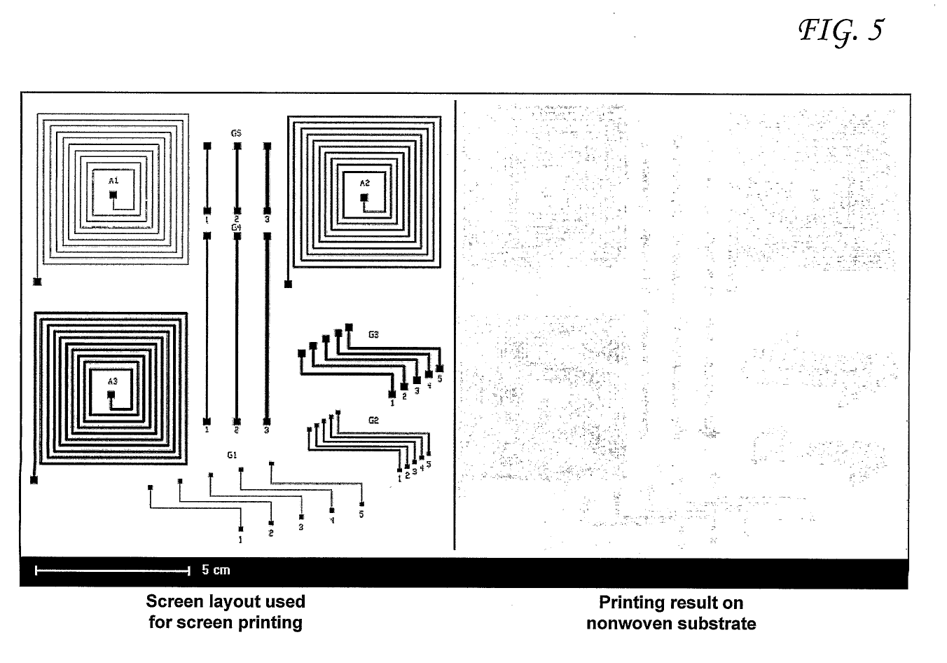

FIG. 5 illustrates the circuit patterns created within an electrical component in accordance with an exemplary embodiment of the present invention. In accordance with certain exemplary embodiments of the present invention, desired circuitry can be designed and implemented into the electrical component. As shown in FIG. 5, in a non-limiting example, conductive ink can be screen printed onto the nonwoven substrate in a desired pattern to create conductive circuitry, such as the various antennas and transmission lines shown in FIG. 5. The diagram on the left hand side of FIG. 5 provides the screen layout which can used in the screen printing process. The diagram on the right side of FIG. 5 provides the resulting conductive circuitry as applied to the surface of a nonwoven substrate.

A significant factor in the application of the conductive ink to the nonwoven fabric is the resultant contact angle between the conductive ink and surface of the nonwoven fabric. The contact angle is defined by angle between the fluid on top of the nonwoven fabric and the fabric surface. If this angle is too large such as ninety degrees, than a significant portion of the conductive ink can be exposed above the surface of the nonwoven fabric. This exposure can be susceptible to dislodging from the nonwoven fabric. Dislodging of the conductive ink can result degrade the integrity of the conductive circuit enabled by the conductive ink and the conductive circuit being broken. Accordingly, a lower contact angle is desired and preferably an angle less than 60 degrees is preferred with an optimum angle being closest to zero degrees.

This contact angle is created depending on how much conductive ink is utilized, how it is applied, the wettability of the fabric surface and the pore size and frequency for permitting some of the ink to enter into the fabric in the z-direction. Furthermore, the contact angle is measured after adequate time to enable the ink to maintain a static position which would be representative of the ink once cured. If the contact angle is insufficient, the wettability of the fabric may be changed by manipulating the surface properties of the fiber.

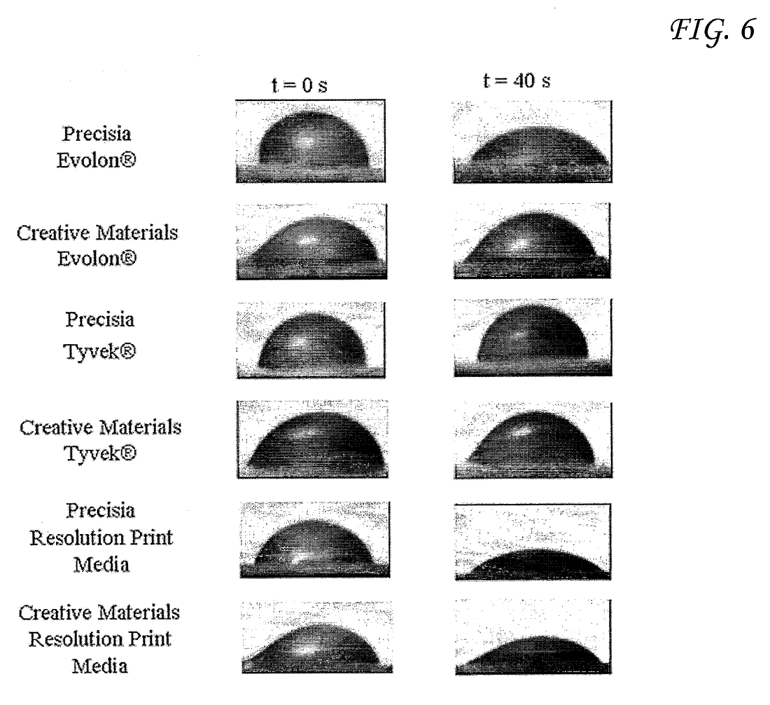

FIG. 6 illustrates various contact angles at particular instances of time for different conductive inks applied to different nonwoven substrates in accordance with an exemplary embodiment of the present invention. As shown in FIG. 6, the contact angle can vary with the type of conductive ink used and the type of nonwoven substrate. A high speed camera was used to capture the images provided in FIG. 6 to illustrate the interaction of single droplets of conductive ink with the nonwoven substrates. The higher viscosity ink, Creative Materials ink, tends to remain on the substrate while the lower viscosity ink, Precisia, penetrates through the nonwoven. Tyvek® behaves almost like a film where the conductive ink droplets barely penetrate into the structure due to very few and small capillaries on the surface. However, both in plane and through the plane penetration of ink droplets is observed on Evolon® due to its three dimensional structure with very fine fibers. RPM absorbs the ink droplets the most due to larger capillaries on its surface.

Accordingly, opportunities exist to engineer the Evolon® nonwoven substrate surface properties to assist in maintaining a conductive circuit intact within a fabric while also engineering the network geometry and capillary structure of the nonwoven in the z-direction to permit some of the ink to penetrate into the fabric in the z-direction. By allowing the ink to flow into the fabric, roots can basically be created supporting the ink on the surface. The conductive circuit created by “printing” the ink onto the fabric is mainly located at the surface of the fabric. However, by permitting the ink to penetrate into the z-direction, the interaction between the lower portion of the ink droplets and the nonwoven fabric provides for a multitude of surface interactions for maintaining the conductive ink droplets and respective circuit components in place.

The relationship of the conductive ink droplet on the surface with respect to the z-direction portion of the droplet is important. If too much of the ink carries into the z-direction then the droplet supports can be to thin and fail to provide the necessary support. Additionally, if the ink penetrates too far into the fabric the flexibility of the fabric may be restricted. Since the invention relates to circuits which may be incorporated into fabrics, the flexibility of the nonwoven substrate is important. Accordingly, penetration of the ink in the z-direction is desired to be less than 50% of the fabric length.

Limitation of the conductive ink's penetration on the z-direction can be manipulated based upon the velocity which the ink is dropped onto the fabric during its application which may be done via screen printing or an ink jet. In some exemplary embodiments, velocities may range from 1 m/s to 4 m/s and provide a suitable pattern, while larger velocities may not be acceptable. Another factor in the manipulation of the ink in the z-direction involves the viscosity of the ink itself.

In alternative embodiments, polymer thick film technology can be utilized. The polymer thick films are screen printable inks and can be applied to the nonwoven substrate. The polymer thick films can be conductive, resistive or insulative in nature resulting in certain patterns to be created onto the nonwoven fabric including those patterns functioning as conductive paths, capacitor electrodes, bondable pads, edge arounds, through hole connectors, resistors, thermistors, capacitors, crossovers, overglazes and the like.

In some embodiments of the present invention, it is possible to match the nonwoven substrate to the thermal characteristics of the polymer thick film used. For the polymer thick film, the curing temperatures can range from room temperature up to 850 degrees centigrade, can be either IR or UV curable with the UV curable inks being solvent free and having a faster cure time than IR cured inks.

Those embodiments which involve screen printing the polymer thick films present many advantages. The electrical circuits can be printed rapidly and at much lower cost than conventional techniques, such as etching and removal of sheets of cooper. Many polymer blends and wide range of substrates are possible and multilayer circuits can be printed. Factors in considering which polymeric thick films to utilize and the relationship to the nonwoven substrate include the rheology of the ink, the squeegee rate and pressure of the ink, the surface tension of the ink, the screen materials and residence time on the screen. Inks having high viscosity and high internal cohesion yields the best printing results, but nonetheless can be utilized with a nonwoven substrate which has sufficient pore area.

Certain factors such as mesh size and application by squeegee also affected the conductive ink pattern. For instance, the sharpness of the squeegee affected how much ink could be processed through the mesh screen. Also a softer squeegee yielded thicker films while an angle at 45 degrees provided more downward pressure than a 90 degree angle. For screen mesh count, a 200 (threads/inch) mesh count was utilized. The mesh count could be increased to 250-400 to produce higher resolution images. Unfortunately, the ink deposit decreases with increasing mesh count. Since a high ink deposit on the Evolon fabrics is needed due to their absorbent nature, a low mesh count screen of 200 produces the better results. Also, in samples conducted, the ink was applied at 5.94 cm/s.

The exemplary embodiment of the present invention can provide a circuit in a fabric capable of withstanding external forces and maintaining its conductive integrity. In order to evaluate the conductive integrity, the impedance of the circuits was evaluated for certain exemplary embodiments of the present invention. Additionally, to evaluate the ability to construct circuits which would exhibit the necessary electrical characteristics, various samples of circuits were created utilizing the different inks and substrates. For instance, for a desired circuit wherein the signal line is intended to be approximately 1400 μm the gap of the ground to the right and left of the signal line is intended to be 400 μm. From the various inks and substrates, various results can be obtained, indicating the feasibility of printing the circuits onto the nonwoven substrates. As previously mentioned, a component to the overall circuit design is the viscosity and surface tension of the ink. The CMI 112-15 ink, with a viscosity at 50 rpm of 48880 cp and a surface tension of 39 dynes/cm, performed well.

Even if desired circuits are created, a problem exists in that the lines crack for usage and washings. Washings of the electrical components can result in the degradation of the integrity of the conductive circuits of the electrical components.

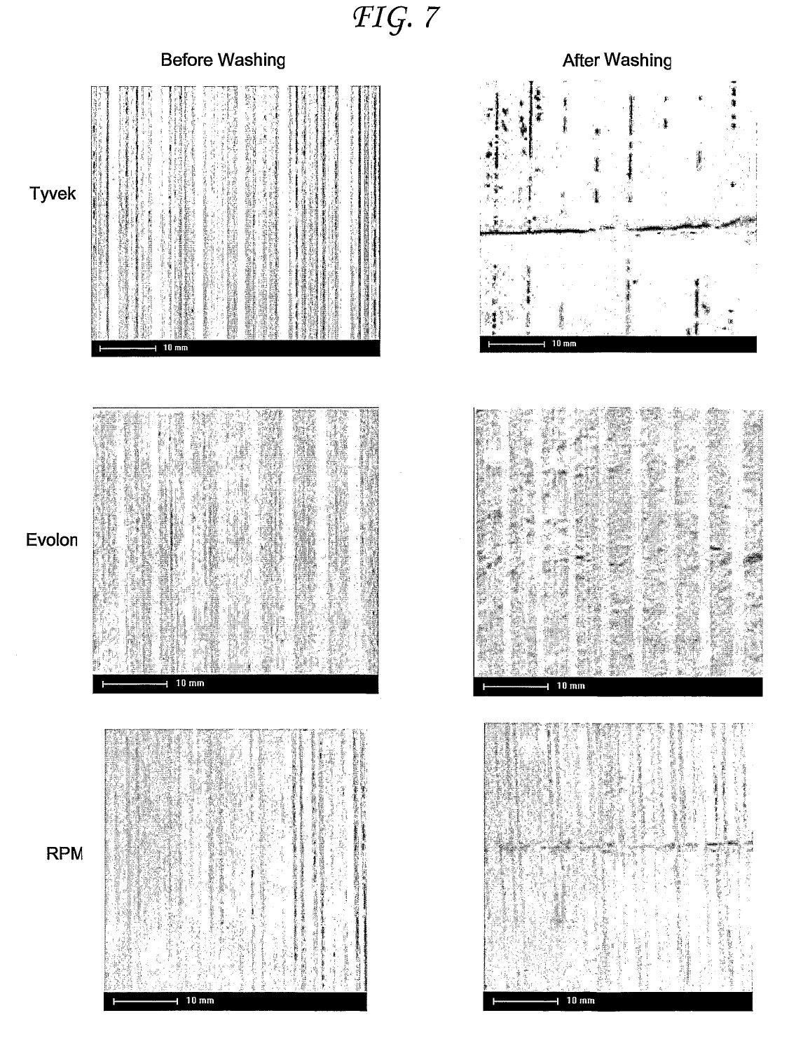

FIG. 7 displays the results of washing electrical components of various nonwoven substrates after the application of the conductive ink. FIG. 7 displays the effects of exposure of the electrical components to numerous wash cycles. The electrical components shown in FIG. 7 were created with three different types of nonwoven substrates, including Tyvek®, Evolon®, and RPM. The left hand column of micrographs illustrates the electrical components before exposure to washing cycles. The right hand column of FIG. 7 illustrates the electrical components after exposure to numerous washing cycles. The after washing image of the conductive ink applied to the Tyvek® nonwoven substrate illustrates that the majority of the conductive ink was removed from the surface of the nonwoven substrate. The after washing image of the conduct ink applied to the Evolon® nonwoven substrate shows that this electrical component proved to more durable and resilient to the stress of washing cycles. As shown in FIG. 7, the traces for the conductive ink on the Evolon® nonwoven substrate exhibit micro fractures and breaks. While not as severe as the Tyvek® nonwoven substrate, these defects can degrade the integrity of the conductive circuit created by the traces. Furthermore, the bottom row of FIG. 7 illustrates that the conductive ink applied to a RPM nonwoven substrate was also somewhat degraded by exposure to washing cycles.

The exemplary embodiments of the present invention overcome the problems associated with the degradation to the circuit integrity due to stress exposure by sealing the surface of the electrical component. Thus, in order to improve the durability properties of the electrical components without sacrificing the flexibility or the breathability of the substrates, the electrical components can be coated with a laminate. This laminate can be a lightweight, flexible, elastomeric breathable layer that prevents the substrates from creasing during laundering and also protects the ink and keeps the ink sandwiched and in place during deformation. Significantly, even if cracks and breaks are created in the conductive ink, the laminate layer can hold the conductive ink together. The lamination can also create a mechanical barrier and help to decrease the wearing away of the conductive ink during washing. In an exemplary embodiment, for fabrics intended as clothing, a solution to the durability, washability, breathability and flexibility of the circuit and substrate is achieved by providing a laminate over the circuit area of the substrate.

In an exemplary embodiment, the laminate can be a meltblown coating of thermoplastic urethane (TPU). In some embodiments the TPU utilized can have fine fibers of 2 μm, with very fine pores. The meltblown outer barrier coating may be applied wet or dry in combination with an adhesive layer. Those of skill in the art will appreciate that numerous materials can be used for the laminate layer other than TPU.

The following steps provide a non-limiting example of the method adhering the TPU to the electrical component. The conductive ink can first be printed onto the nonwoven substrate in transmission lines of 10 cm length and cured. A polyamide adhesive web can then be placed between the meltblown TPU and a nonwoven substrate in order to provide adhesion between the TPU and nonwoven substrate. The dimensions of the length and width of the adhesive web in an exemplary embodiment can be 3.5 inches by 1.25 inches respectively. The dimensions of the meltblown TPU layer in an exemplary embodiment can be 10 cm in length and 1.25 inches in width. Once the adhesive web and meltblown TPU layer are placed on the nonwoven substrate, the samples can be processed by a fusing machine. In a non-limiting example, a Kannegiesser model fusing machine can be used. In an exemplary embodiment, the samples can be placed on a moving belt and laminated between two sets of rollers by means of heat and pressure. For example, and not limitation, for Evolon and Tyvek the selected temperatures can be 150 C. and 120 C. respectively and the speed of the process can be 3 m/min. Completing the lamination step with the adhesive web fuses the meltblown TPU layer to the nonwoven substrate and makes it very difficult to separate the meltblown TPU layer from the nonwoven substrate.

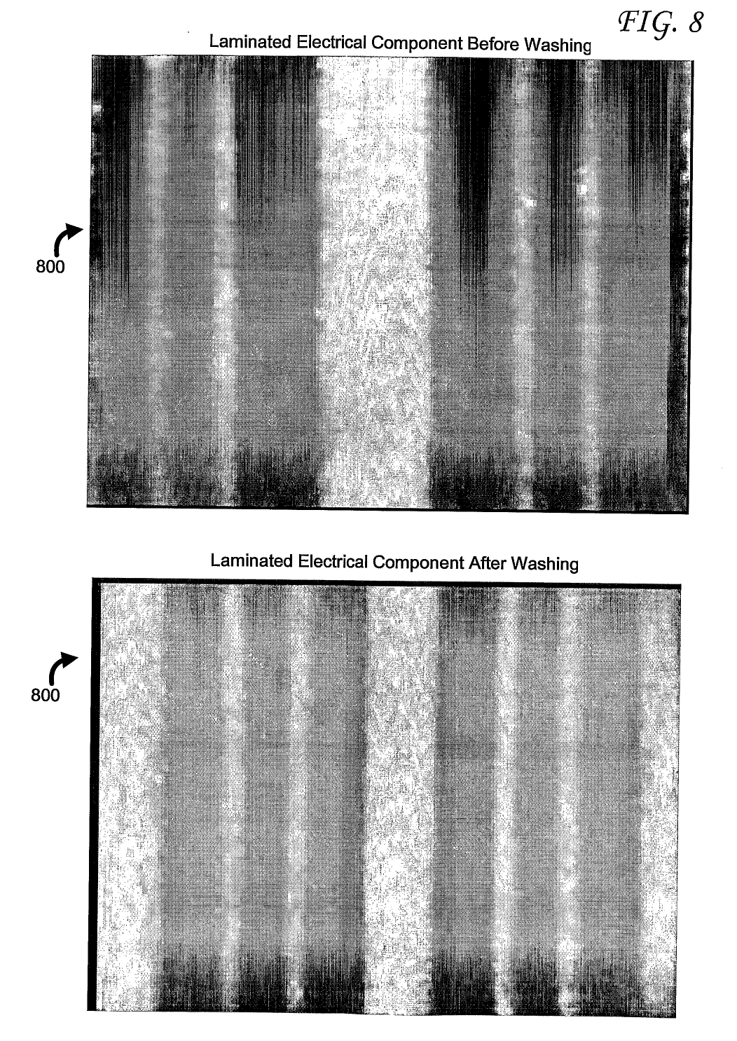

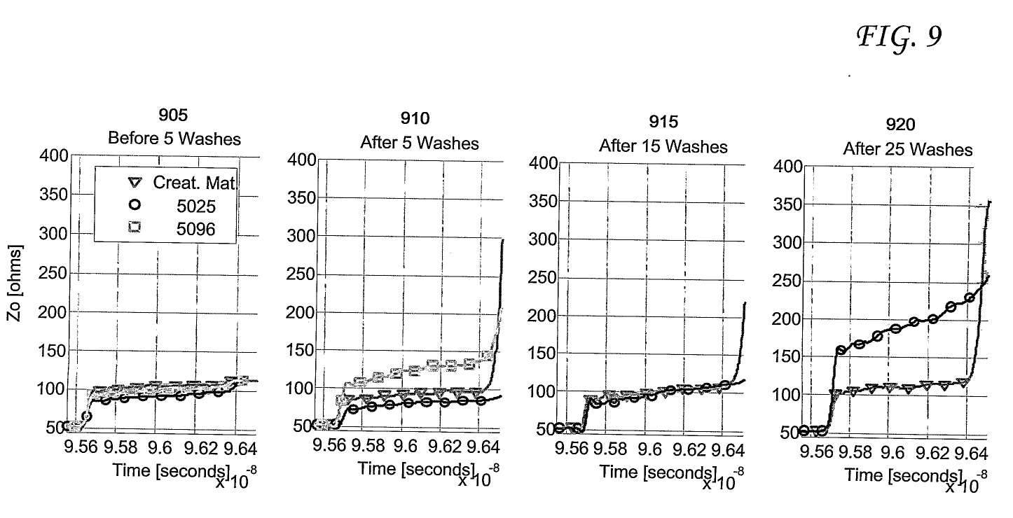

FIG. 8 displays the results of the exposure of an electrical component 800, created in accordance with an exemplary embodiment of the present invention, to deforming stress. The micrograph image at the top of FIG. 8 illustrates an electrical component 800 sealed with a meltblown TPU layer before washing. The micrograph image shown at the bottom on FIG. 8 illustrates the electrical component 800 after exposure to 25 wash cycles. As can be seen in the bottom image of FIG. 8, the electrical component 800 does not exhibit any breaks or cracks in the conductive ink traces. In comparison to the result of washing to the electrical components shown in FIG. 7, the durability and robustness of the electrical component 800 sealed with a meltblown TPU layer is significantly improved to those with a seal. Therefore, as shown in FIG. 8, the application of the laminate layer significantly increases the durability and integrity of the electrical component upon exposure to deforming stress.

Table 4 below provides the results of an evaluation of an exemplary embodiments of electrical components constructed in accordance with the present invention. Three different electrical components were evaluated for Table 4, including a first laminated electrical component in which Creative Materials conductive ink was applied to an Evolon® nonwoven substrate, a second laminated electrical component in which DuPont 5025 conductive ink was applied to an Evolon® nonwoven substrate, and third a laminated electrical component in which DuPont 5025 conductive ink was applied to an Evolon® nonwoven substrate. The electrical properties (DC resistance and characteristic impedance) of three traces from each of these three electrical components were recorded after exposure to a series of washings to evaluate the durability and integrity of the conductive circuits of the various electrical components. The washings were administered in accordance with to ISO 6330.

TABLE 4

| | | Before Washing | | | After Washing | | |
|---|---|---|---|---|---|---|---|
| | | Line 1 | Line 2 | Line 3 | Line 1 | Line 2 | Line 3 |
| Conductive Ink | Washes | (ohms) | (ohms) | (ohms) | (ohms) | (ohms) | (ohms) |
| Creative Materials | 5 | 3.0 | 2.3 | 2.6 | 7.8 | 4.4 | 4.9 |
| Dupont 5025 | 5 | 5.4 | 5.4 | 5.9 | 6.5 | 6.7 | 9.3 |
| Dupont 5096 | 5 | 7.8 | 7.9 | 8.1 | 20.8 | 30 | 23.9 |
| Creative Materials | 15 | 2.4 | 2.5 | 2.3 | 10.3 | 9.6 | 13 |
| Dupont 5025 | 15 | 6.3 | 6.1 | 6.3 | 27.7 | 17.4 | 61.5 |
| Dupont 5096 | 15 | 7.8 | 8.0 | 7.6 | 21.2 | 16.9 | 18.7 |
| Creative Materials | 25 | 2.2 | 2.2 | 2.3 | 12.2 | 11.8 | 10 |
| Dupont 5025 | 25 | 6.0 | 5.9 | 5.7 | 80 | 47 | 54 |
| Dupont 5096 | 25 | 7.2 | 6.9 | 7.1 | failed | failed | failed |

As illustrated in Table 4, the electrical components sealed with a laminate layer are durable and robust. The resistance figures of Table 4 illustrate the integrity of conductive ink traces of the three electrical components tested after 5, 15, and 25 washes. All three electrical components maintained low resistance values, and thus good circuit integrity, for the conductive ink traces after exposure to 5 washes. Similarly, the resistance values increased a minimal amount after exposure to the deforming stress of 15 washes. After 25 washes, only the electrical component created from Dupont 5096 conductive ink failed. The two other electrical components successfully preserved a conductive ink trace even after being subject to the deforming stress of 25 washes. As shown in Table 4, the electrical component created with Creative Materials conductive ink on a Evolon® nonwoven substrate maintained the highest level of conductive circuit integrity over the longest stress exposure period, however, the electrical component created with Dupont 5025 conductive ink exhibited the smallest increase in resistance after only 5 washings.

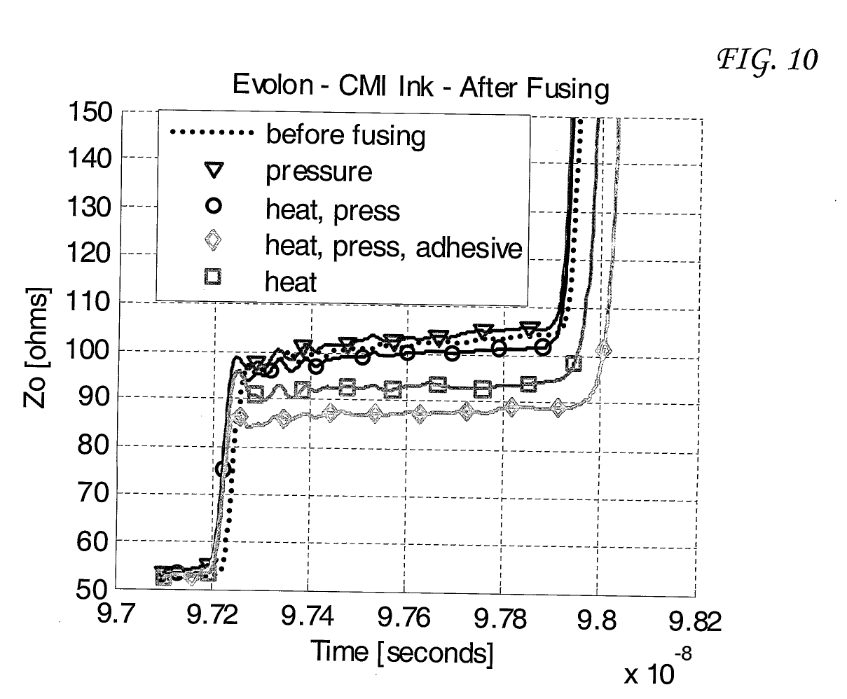

FIG. 9 provides a series of time-domain reflectometry graphs of three electrical components created in accordance with an exemplary embodiment of the present invention. Time-domain reflectometry (“TDR”) uses a time-domain reflectometer to characterize and locate faults in a conductor by sending a fast rise time pulse along the conductor and monitoring any reflections on the conductor. The graphs provided in FIG. 9 illustrate the TDR results for the three embodiments of the electrical components evaluated in Table 4. These electrical components were created from three different conductive inks, all applied on an Evolon® nonwoven substrate. Before 5 washes, the TDR results, shown in graph 905, for all three electrical components exhibit a smooth impedance profile. The graph 910 illustrates that after 5 washes, all three electrical components maintain a smooth impedance profile. After 15 wishes, the graph 915 illustrates that both the electrical component with the Creative Materials conductive ink and the electrical component with the Dupont 5025 conductive ink maintained a proper impedance profile, and thus the conductive traces have not been compromised. Graph 920 illustrates that after 25 washes, the impedance profile for the electrical component with the Creative Materials conductive ink is superior to that of the electrical component with the Dupont 5025 conductive ink.

FIG. 10 provides a time-domain reflectometry graph for an electrical component in accordance with an exemplary embodiment of the present invention. The plot lines in the graph for FIG. 10 provide the TDR results for an electrical component with Creative Materials conductive ink on a Evolon® nonwoven substrate after exposure to heat, pressure, and adhesive. As illustrated in the graph of FIG. 10, heat, pressure, and adhesive have virtually no effect on the impedance profile of the electrical component with Creative Materials conductive ink on a Evolon® nonwoven substrate.

The breathability of the outer barrier is important as one of the preferred embodiments of the final product will be a wearable electronic and the circuit and substrate will be a part of the garment. Accordingly, the barrier for some embodiments has to be breathable in order to remove the moisture vapor generated during the sweating of the body. A TPU laminate layer can create a microporous structure which blocks the fluid away and passes the moisture vapor. The TPU laminate layer has very fine fibers with a diameter around 1-5 microns and pores less than 10 microns in diameter. The size of moisture vapor is around 0.0004 microns and the size of a water droplet is around 100 microns.

The parameter that is used to describe that the barrier prevents water from permeating into the ink while maintaining the breathability of the moisture vapor rate is porosity. The pore size is controlled by fiber size and fabric density. Small pores can only be obtained by low basis weight fabrics and in order to obtain low basis weight fabric, small fibers should be used.

The electrical component should be flexible enough to conform to the body shape. Conductive thick films are subjected to crease and folding stresses and should be flexible in order to resist repeated stretching and bending deformations during use. The flexibility of the ink should equal or exceed that of the substrate in order to bend without cracking or peeling. A suitable standard of measurement includes the Massachusetts Institute of Technology fold endurance test (ASTM Test D2176-69) which is a controlled and accelerated ink flex test and wherein the coating is flexed over a 270-degree arc under controlled conditions and the resistance increase across the fold versus the number of cycles is measured.

From the invention as described above, multiple circuit designs are available. Structural simulation and modeling is possible for creating nonwoven fabrics having specific fiber orientations for enabling conductive ink to enter via pores in the z-direction providing for stable circuits. Various inks and their viscosities can be modeled to assist in the application of the inks for creating the appropriate contact angles. For fabrics which are intended to be worn, a durable and flexible lamination method is available that protects the printed ink from washing away and fracturing.

The numerous embodiments of the present invention enable a flexible electronic device that present many advantages over the prior art and provides opportunities for many novel applications. Exemplary embodiments of the present invention can be used to create flexible printed circuits in applications such as RFID (radio frequency identification) tags, and wearable electronic devices and “intelligent textiles”. Examples of smart textiles incorporating the exemplary embodiments of the present invention include clothing that can dispense medication, clothing that provide fragrance or change of color in response to change in body temperature, ski jackets with embedded radios and music players, electronically networked carpet that controls lighting, adjust temperature, monitor security and improve fire safety. Additionally, military applications include electronics that could transform clothes into biometric bodysuits that detects wearer's vital signals. Use of conductive inks for flexible printed circuits in accordance with the exemplary embodiment of the present invention can provide improvement in durability, reliability, circuit speeds and reduction in circuit sizes over the traditional production techniques. The exemplary embodiments of the present invention can allow electronic manufacturers to develop smaller, reduced weight, circuits even on flexible substrates, textiles and paper.

While the various embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. An electrical component comprising:
a nonwoven substrate having a general depth in the z-direction; and
a conductive ink carried by the nonwoven substrate on the surface of the substrate and at least partially but no more than 50% within the substrate in the z-direction.

2. The electrical component of claim 1 wherein the conductive ink includes a cured droplet having a contact angle less than 70 degrees.

3. The electrical component of claim 1 further including a laminate film layer overlaying the conductive ink.

4. The electrical component of claim 3 wherein said laminate layer includes fibers having a diameter around 1-5 microns and pores less than 10 microns in diameter.

5. The electrical component of claim 4 wherein said fibers are meltblown fibers.

6. The electrical component of claim 3 wherein said laminate layer exhibits a moisture vapor permeability between 2000-4000 grams/m squared/day.

7. The electrical component of claim 3 wherein said laminate layer is fastened to said nonwoven material.

8. The electrical component of claim 1 wherein said ink consists of a fluid having a viscosity greater than 340 p at 50 rpm.

9. The electrical component of claim 1 wherein said ink consists of a fluid having a surface tension of at least 36 dynes/cm.

10. An article of manufacture having an electrical component of claim 1 attached therein.

11. A method of establishing a circuit comprising:
providing a substrate having a predetermined depth;
applying a conductive ink to said substrate such that ink permeates through said substrate to a depth no greater than 50% of said predetermined depth; and
said conductive ink applied to said substrate in such a manner to provide for conductive circuitry.

12. The method of claim 11 wherein said substrate is a nonwoven fabric.

13. The method of claim 11 further including applying a laminated film over said conductive ink substantially isolating said conductive ink from the ambient environment.

14. The method of claim 13 further including attaching said laminated film to said substrate.

15. The method of claim 13 further including applying a polyamide adhesive web between said laminated film which is comprised of a meltblown material and said substrate which is comprised of a nonwoven fabric.

16. The method of claim 15 further including fusing said adhesive, film and substrate together utilizing a fusing machine.

17. The method of claim 13 further including attaching said circuit to a second body of material.

18. The method of claim 13 wherein said laminated film is comprised of a meltblown material having an air permeability of between 2000-4000 grams/m squared/day.

19. The method of claim 13 wherein said film is comprised of a thermoplastic urethane meltblown layer.

20. A method of providing a flexible electronic component comprising the steps of:
providing a nonwoven substrate having a general depth in the z-direction;
applying a conductive ink to said nonwoven substrate, wherein said conductive ink is carried by the nonwoven substrate on the surface of the substrate and at least partially but no more than 50% within the substrate in the z-direction; and
sealing said conductive ink carried by said nonwoven substrate with a thermoplastic polymer coating.
